(19) United States
(12) Patent Application Publication
(10) Pub. No.: US 2005/0283415 A1
(43) Pub. Date: Dec. 22, 2005

(54) System and method for displaying market data including last trade data

(75) Inventors: Ari Studnitzer, Chicago, IL (US); Dennis Genetski, Porter, IN (US); Bart Hrvatin, Chicago, IL (US); Seshadri Sundaram, Aurora, IL (US)

Correspondence Address: BANNER & WITCOFF, LTD., TEN SOUTH WACKER DRIVE, SUITE 3000, CHICAGO, IL, 60606, US

(73) Assignee: Chicago Mercantile Exchange, Chicago, IL (US)

(21) Appl. No.: 10/874,561

(22) Filed: Jun. 22, 2004

(51) Int. Cl. G06F 17/60

(52) U.S. Cl. 705/35

(57) ABSTRACT

Systems, methods and user interfaces are provided for augmenting snapshots of market depth information. Visually perceptible elements, such as icons and background shading, may be used to represent trades that have occurred after a first snapshot of market depth information and before a second snapshot of market depth information. Audible signals may also be used to represent such trades.

### FIELD OF THE INVENTION

The present invention relates to systems, methods and user interfaces that are utilized in connection with the trading of financial instruments. More particularly, the invention provides mechanisms for distributing and displaying snapshots of market data and trade data representing trades that have occurred since the last snapshot.

### DESCRIPTION OF THE RELATED ART

It is common for exchanges to allow traders to conduct transactions with handheld devices and larger computer devices. Attempts have been made to present rapidly changing information to traders in a form that allows the traders to quickly absorb and act on the information. Conventionally, snapshots of market depth data are periodically transmitted from an exchange to handheld devices and larger computer devices.

One drawback associated with this conventional approach to distributing market depth data is that it is common for market depth data to change at times in between the transmission of the periodic snapshots. This results in users not having accurate market depth information. Without accurate information, traders may make trading decisions that cannot be fulfilled, because the market has moved since the transmission of the last snapshot. The lack of accurate information may also result in traders making trading decisions that they would not otherwise make. Making decisions based on inaccurate market depth information can be frustrating and costly for traders.

Therefore, there is a need in the art for systems, methods and user interfaces that utilize mechanisms for providing more accurate market depth information.

### SUMMARY OF THE INVENTION

The present invention overcomes at least some of the problems and limitations of the prior art by providing systems, methods and user interfaces that augment snapshots of market depth information with data representing trades that have occurred since the last snapshot of market depth information. A snapshot of market depth information includes data representing at least some orders that were or are pending at a given point in time. The augmentation may include an icon, background coloring of cells, columns or rows or other mechanisms that are visually or audibly perceptible to traders.

In various embodiments, the present invention can be partially or wholly implemented on a computer-readable medium, for example, by storing computer-executable instructions or modules, or by utilizing computer-readable data structures.

Of course, the methods and systems disclosed herein may also include other additional elements, steps, computer-executable instructions, or computer-readable data structures.

The details of these and other embodiments of the present invention are set forth in the accompanying drawings and the description below. Other features and advantages of the invention will be apparent from the description and drawings, and from the claims.

### BRIEF DESCRIPTION OF THE DRAWINGS

The present invention may take physical form in certain parts and steps, embodiments of which will be described in detail in the following description and illustrated in the accompanying drawings that form a part hereof, wherein:

FIG. 1 shows a computer network system that may be used to implement aspects of the present invention;

FIG. 2 illustrates a method of processing and displaying market information in accordance with an embodiment of the invention;

FIG. 3 illustrates an exemplary graphical user interface that may be used to display market depth information and allow traders to trade financial instruments in accordance with an embodiment of the invention;

FIG. 4 illustrates an embodiment that uses background shading to represent trade data, in accordance with an embodiment of the invention;

FIG. 5 illustrates an embodiment of the invention in which trade data for multiple trades is received after receiving data representing a first snapshot of market depth information, in accordance with an embodiment of the invention; and

FIG. 6 illustrates an embodiment of the invention in which a portion of a background of a cell is changed to represent the number of contracts that have traded since the transmission of the last snapshot of market depth information, in accordance with an embodiment of the invention.

### DETAILED DESCRIPTION OF THE INVENTION

Exemplary Operating Environment

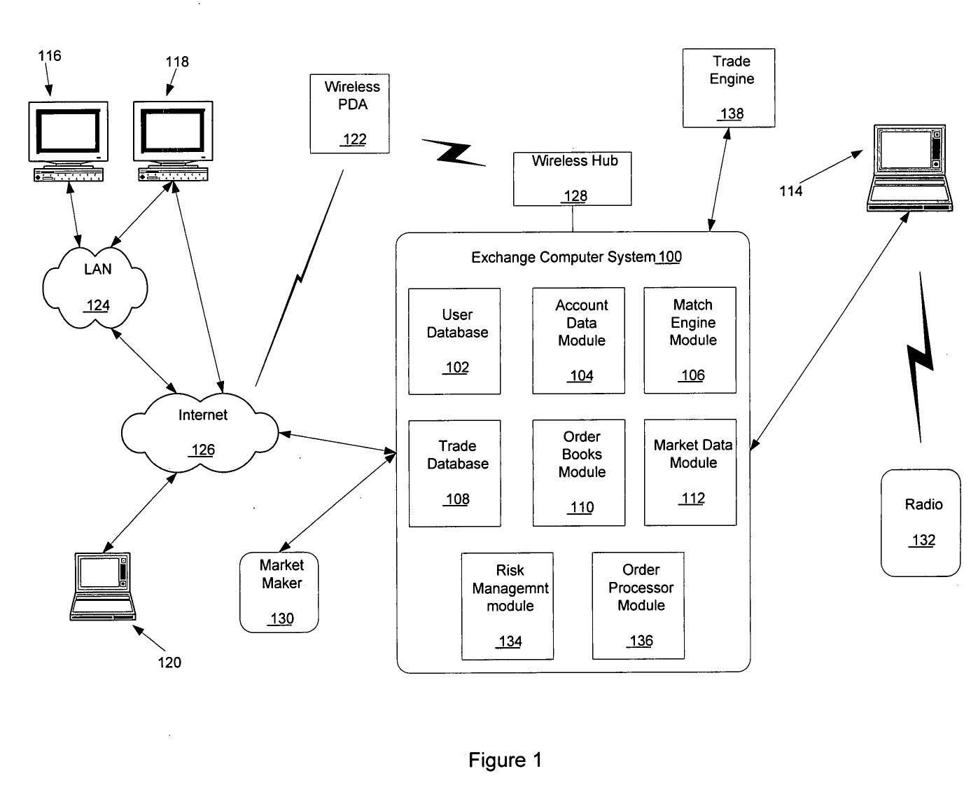

Aspects of the present invention are preferably implemented with computer devices and computer networks that allow users to exchange trading information. An exemplary trading network environment for implementing trading systems and methods is shown in FIG. 1.

An exchange computer system 100 receives orders and transmits market data related to orders and trades to users. Exchange computer system 100 may be implemented with one or more mainframe, desktop or other computers. A user database 102 includes information identifying traders and other users of exchange computer system 100. Data may include user names and passwords. An account data module 104 may process account information that may be used during trades. A match engine module 106 is included to match bid and offer prices. Match engine module 106 may be implemented with software that executes one or more algorithms for matching bids and offers. A trade database 108 may be included to store information identifying trades and descriptions of trades. In particular, a trade database may store information identifying the time that a trade took place and the contract price. An order book module 110 may be included to compute or otherwise determine current bid and offer prices. A market data module 112 may be included to collect market data and prepare the data for transmission to users. A risk management module 134 may be included to compute and determine a user's risk utilization in relation to the user's defined risk thresholds. An order processing module 136 may be included to decompose delta based and bulk order types for processing by order book module 110 and match engine module 106.

The trading network environment shown in FIG. 1 includes computer devices 114, 116, 118, 120 and 122. Each computer device includes a central processor that controls the overall operation of the computer and a system bus that connects the central processor to one or more conventional components, such as a network card or modem. Each computer device may also include a variety of interface units and drives for reading and writing data or files. Depending on the type of computer device, a user can interact with the computer with a keyboard, pointing device, microphone, pen device or other input device.

Computer device 114 is shown directly connected to exchange computer system 100.

Exchange computer system 100 and computer device 114 may be connected via a T1 line, a common local area network (LAN) or other mechanism for connecting computer devices. Computer device 114 is shown connected to a radio 132. The user of radio 132 may be a trader or exchange employee. The radio user may transmit orders or other information to a user of computer device 114. The user of computer device 114 may then transmit the trade or other information to exchange computer system 100.

Computer devices 116 and 118 are coupled to a LAN 124. LAN 124 may have one or more of the well-known LAN topologies and may use a variety of different protocols, such as Ethernet. Computers 116 and 118 may communicate with each other and other computers and devices connected to LAN 124. Computers and other devices may be connected to LAN 124 via twisted pair wires, coaxial cable, fiber optics or other media. Alternatively, a wireless personal digital assistant device (PDA) 122 may communicate with LAN 124 or the Internet 126 via radio waves. PDA 122 may also communicate with exchange computer system 100 via a conventional wireless hub 128. As used herein, a PDA includes mobile telephones and other wireless devices that communicate with a network via radio waves.

FIG. 1 also shows LAN 124 connected to the Internet 126. LAN 124 may include a router to connect LAN 124 to the Internet 126. Computer device 120 is shown connected directly to the Internet 126. The connection may be via a modem, DSL line, satellite dish or any other device for connecting a computer device to the Internet.

One or more market makers 130 may maintain a market by providing constant bid and offer prices for a derivative or security to exchange computer system 100. Exchange computer system 100 may also exchange information with other trade engines, such as trade engine 138. One skilled in the art will appreciate that numerous additional computers and systems may be coupled to exchange computer system 100. Such computers and systems may include clearing, regulatory and fee systems.

The operations of computer devices and systems shown in FIG. 1 may be controlled by computer-executable instructions stored on computer-readable medium. For example, computer device 116 may include computer-executable instructions for receiving order information from a user and transmitting that order information to exchange computer system 100. In another example, computer device 118 may include computer-executable instructions for receiving market data from exchange computer system 100 and displaying that information to a user.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may be connected by numerous alternative topologies.

### Exemplary Embodiments

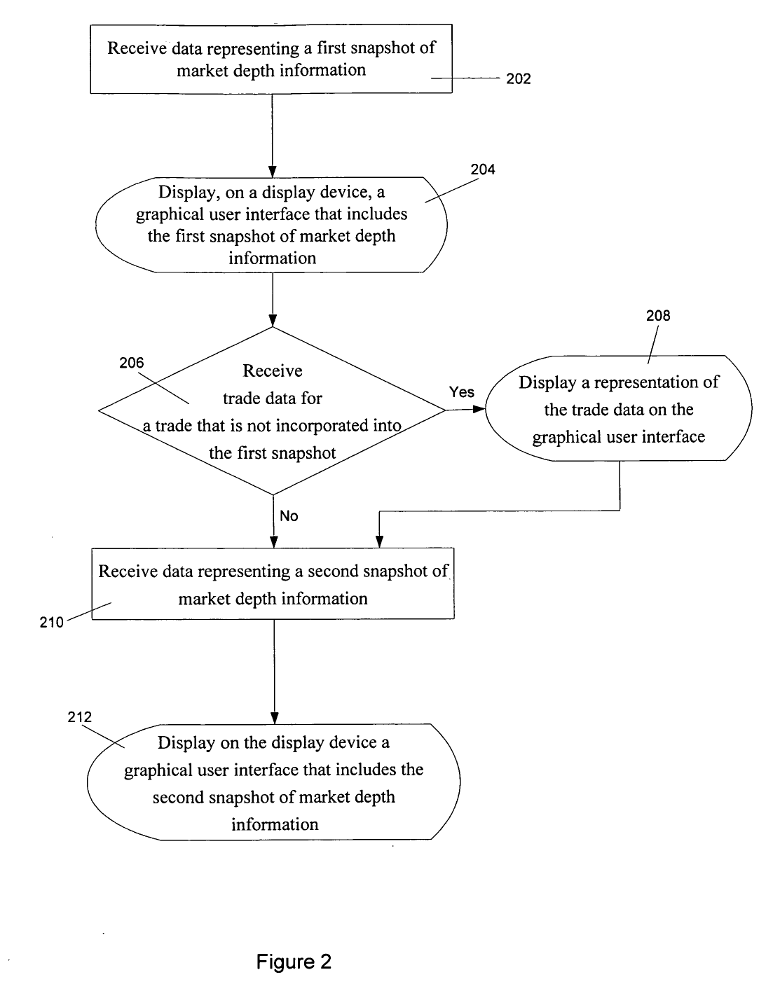

FIG. 2 illustrates a method of processing and displaying market information in accordance with an embodiment of the invention. The method may be implemented as computer-readable instructions recorded on a computer readable medium, such as an optical disk or RAM or ROM memory module. First, in step 202 data representing a first snapshot of market depth information is received. A snapshot of market depth information represents the state of a market at a fixed period of time. The information may be received at a desktop computer, mobile terminal or any other device that is used for trading financial instruments at an exchange. The market depth information may be formatted in accordance with conventional formats used to distribute snapshots of market depth information. After the information is received, in step 204 a graphical user interface that includes the first snapshot of market depth information is displayed on display device.

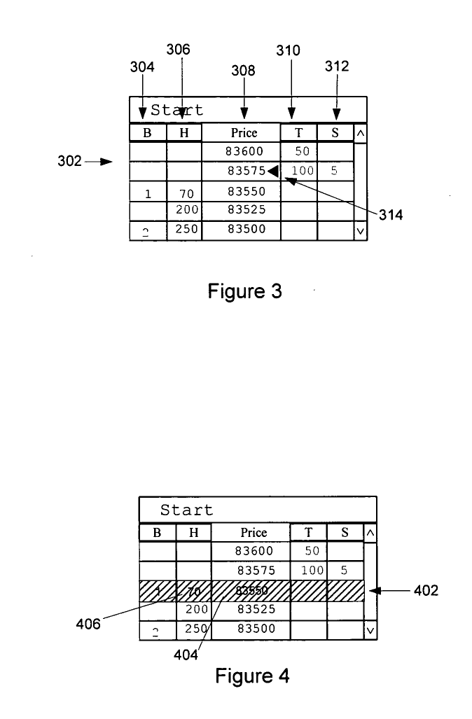

FIG. 3 illustrates an exemplary graphical user interface 300 that may be used to display market depth information and allow traders to trade financial instruments in accordance with an embodiment of the invention. Graphical user interface 300 includes a price and quantity grid 302. Price and quantity grid 302 may contain five columns. A buy column 304 displays a user's working buy order quantities. As used herein, a user may be a trader. A hit column 306 displays the market bid quantities. Prices for individual rows are displayed in a price column 308. A take column 310 displays market ask quantities. And, a sell column 312 displays a user's working sell order quantities. Individual entries may be color coded to assist users in quickly interpreting the displayed information. For example, entries in buy column 304 and hit column 306 may be in blue and entries in take column 310 and sell column 312 may be in red.

After the first snapshot of market depth information is displayed in step 204 it is determined whether additional trade data is received. The trade data is for one or more trades that have occurred after an exchange or other source of market data transmits the first snapshot of market depth information identified in step 202 and before the exchange or other source of market data transmits another snapshot of market depth information. When such data is received, in step 208 a representation of the trade data is displayed on the graphical user interface.

There are many visually perceptible mechanisms that may be used to represent the trade data received. For example, FIG. 3 shows an icon 314 placed next to a price. The position of icon 314 indicates that a trade was executed at the price 83575 after the transmission of the first snapshot of market depth information. With this information, a user would quickly recognize that a transaction occurred at this price after the first snapshot of market depth information.

FIG. 4 illustrates an alternative mechanism they may be used to display a representation of trade data, in accordance with an embodiment of the invention. In particular, the appearance of the background of row 402 has been changed to indicate that a trade occurred at the indicated price. In one embodiment, the color of the background of row 402 is changed to represent the trade. The color used may be a function of the number of contracts involved in the trade. For example, red may indicate that ten or more contracts were traded, orange may indicate that five to nine contracts were traded and yellow may indicate that one to four contracts were traded.

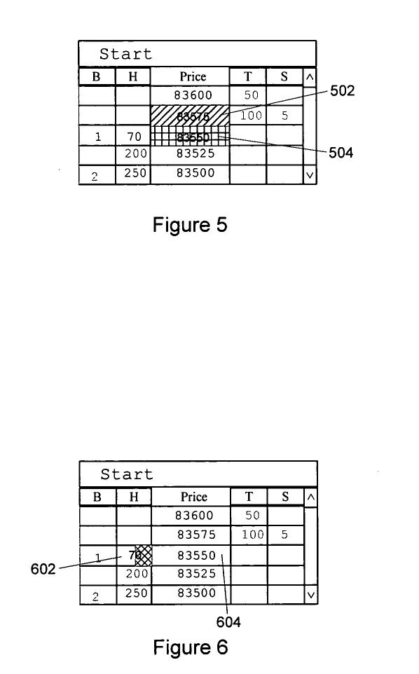

FIG. 5 illustrates yet another embodiment of the invention in which trade data for multiple trades is received after receiving data representing a first snapshot of market depth information, in accordance with an embodiment of the invention. The background of cell 502 has a first visually perceptible characteristic and the background of cell 504 includes a second visually perceptible characteristic. The characteristics may include colors and/or patterns and colors and/or patterns may be selected to indicate the timing of relevant trades. For example, red may indicate the most recent trade price, orange may indicate the second most recent trade price and yellow may indicate the third most recent trade price. FIG. 5 shows that in certain embodiments the backgrounds of individual cells may be changed to represent trade data instead of rows. In a further example referring to FIG. 4, instead of changing the background of row 402, the background of cell 404 and/or cell 406 may be changed.

FIG. 6 illustrates yet another embodiment of the invention in which a portion of a background of cell 602 is changed to represent the number of contracts that have traded since the transmission of the last snapshot of market depth information. Approximately 50% of the background of cell 602 is shaded to represent that 50% of the pending orders have been executed. Of course, this partial shading mechanism may be applied to cell 604 or the entire row containing cells 602 and 604. Moreover, the backgrounds of multiple cells or rows may be partially shaded when trades have occurred at multiple prices.

Returning to FIG. 2, after the representation of the trade data is displayed on the graphical user interface or no trade data is received in step 206, in step 210 data representing a second snapshot of market depth information is received. Then, in step 212 a graphical user interface that includes the second snapshot of market depth information is displayed on the display device. The second snapshot of market depth information incorporates data for all trades that have occurred since the first snapshot market depth information, including any trade data received in step 206. Accordingly, the icon, background shading or other visually perceptible characteristic used to represent the trade data in step 208 may be removed when the updated snapshot of market depth information is received.

In alternative embodiments of the invention, audible signals may be used instead of, or in addition to, the visually perceptible mechanisms described above. For example, tones may be used to represent trade data. Tones having higher frequencies or reproduced at higher volumes may correspond to larger numbers of contracts. In another example, a first tone may represent a trade “at the bid price,” a second tone may represent a trade “at the ask price,” a third tone may represent a trade “above the ask price” and a fourth tone may represent a trade “below the bid price.” Additional, tones could be added for “out of display range high/low.”

Aspects of the present invention may be used in connection with the graphical user interfaces disclosed in commonly assigned U.S. patent application (docket number 006119.00014) entitled “Trader Station User Interface” and filed May 3, 2004. The entire disclosure of this commonly assigned application is hereby incorporated by reference.

The present invention has been described herein with reference to specific exemplary embodiments thereof. It will be apparent to those skilled in the art that a person understanding this invention may conceive of changes or other embodiments or variations, which utilize the principles of this invention without departing from the broader spirit and scope of the invention as set forth in the appended claims. All are considered within the sphere, spirit, and scope of the invention.

1. A computer-readable medium containing computer-executable instructions for causing a computer device to perform the steps comprising:
(a) receiving data representing a first snapshot of market depth information;
(b) displaying on a display device a graphical user interface that includes the first snapshot of market depth information;
(c) at a predetermined time period after (a) receiving data representing a second snapshot of market depth information;
(d) after (a) and before (c), receiving trade data for at least one trade that occurs between receiving the successive snapshots of market depth information; and
(e) displaying a representation of the trade data on the graphical user interface.

2. The computer-readable medium of claim 1, wherein the representation of the trade data comprises an icon placed next to a price.

3. The computer-readable medium of claim 1, wherein the representation of the trade data comprises an alteration in the appearance of at least a price cell of the graphical user interface.

4. The computer-readable medium of claim 3, wherein the alteration in appearance comprises changing a background color.

5. The computer-readable medium of claim 4, wherein the changed background color corresponds to a number of contracts involved in the trade.

6. The computer-readable medium of claim 3, wherein the alteration in appearance comprises changing the background color of a portion of the at least price cell, wherein the portion is a function of a number of contracts involved in at the at least one trade.

7. The computer-readable medium of claim 1, wherein (d) comprises receiving trade data for more than one trade and (e) comprises displaying a representation of each trade on the graphical user interface.

8. The computer-readable medium of claim 7, wherein each trade is represented by altering the appearance of at least a price cell of the graphical user interface.

9. The computer-readable medium of claim 8, wherein a relatively more recent trade is represented by changing a background of at least a first price cell to a first color and a relatively less recent trade is represented by changing a background of at least a second price cell to a second color.

10. The computer-readable medium of claim 8, wherein a trade involving a relatively larger number of contracts is represented by changing a background of at least a first price cell to a first color and a trade involving a relatively fewer number of contracts is represented by changing a background of at least a second price cell to a second color.

11. The computer-readable medium of claim 1, further including computer-executable instructions for causing the computer device to perform the step comprising:
(f) after (c) displaying on the display device a graphical user interface that includes the second snapshot of market depth information and does not include the representation of the trade data.

12. The computer-readable medium of claim 1, further including computer-executable instructions for causing the computer device to cause a sound device to represent the trade with an audible tone.

13. The computer-readable medium of claim 1, wherein the computer device comprises a mobile terminal.

14. A method in a computer system for displaying market information on a display device, the method comprising the steps of:
(a) periodically receiving and displaying snapshots of market depth information; and
(b) in time periods that exist between the receiving of snapshots of market depth information, receiving and displaying trade data for at least one trade that has occurred since the last snapshot of market depth information.

15. The method of claim 14, wherein (b) comprises receiving data identifying details of a trade and representing the trade with a visually perceptible element.

16. The method of claim 15, wherein the visually perceptible element comprises an icon.

17. The method of claim 15, wherein the visually perceptible element comprises background shading of at least a cell.

18. The method of claim 15, further including representing the trade with an audibly perceptible characteristic.

19. A method of distributing market information from an exchange, the method comprising:
(a) periodically transmitting snapshots of market depth information; and
(b) in time periods that exist between the transmitting of snapshots in (a), transmitting trade information for at least one trade that has occurred since the last snapshot of market depth information.
